(19) United States
(12) Patent Application Publication
(10) Pub. No.: US 2013/0290862 A1
(43) Pub. Date: Oct. 31, 2013

(54) USER-TAILORED SEARCH ENGINE HOMEPAGE EXPERIENCES

(71) Applicants: RAJEEV CHAND, Redmond, WA (US); ADITYA KRISHNAN, Seattle, WA (US); KEITH W. JEFFERY, Seattle, WA (US); CHEN B. FANG, Bellevue, WA (US)

(72) Inventors: RAJEEV CHAND, Redmond, WA (US); ADITYA KRISHNAN, Seattle, WA (US); KEITH W. JEFFERY, Seattle, WA (US); CHEN B. FANG, Bellevue, WA (US)

(73) Assignee: MICROSOFT CORPORATION, Redmond, WA (US)

(21) Appl. No.: 13/536,603

(22) Filed: Jun. 28, 2012

Related U.S. Application Data
(63) Continuation-in-part of application No. 13/458,515, filed on Apr. 27, 2012.

(51) Int. Cl. G06F 3/01

(52) U.S. Cl. 715/745

(57) ABSTRACT

Systems, methods, and computer-readable storage media are provided for selecting and serving user-customized search engine homepage experiences. Upon receiving a request for presentation of a search engine homepage from a user, data points about the user are accessed to determine the type of homepage experience the requesting user desires to receive. The type of homepage experience the user desires to receive may include a user-tailored image to be presented as the background of the search engine homepage. Upon determining the type of experience the user desires, a search engine homepage experience is selected for the user. In this way, the user is provided with a search engine homepage experience that is tailored to his or her interests and behavior, thus increasing user satisfaction and engagement with the search engine homepage.

### CROSS-REFERENCE TO RELATED APPLICATIONS

This application is a continuation-in-part and claims priority to U.S. application Ser. No. 13/458,515, filed Apr. 27, 2012 and entitled “Integrated Search Engine Homepages,” which application is hereby incorporated by reference as if set forth in its entirety herein.

### BACKGROUND

Typically, the bulk of the search engine homepage experience is editorially-defined and the same for a large segment of users. For instance, content presented in association with the BING search engine homepage (provided by Microsoft Corporation of Redmond, Wash.) is generally provided by a BING search server and is largely the same for users from the same market and having the same language preference. Such a static experience can discourage user engagement, for instance, in cases in which a user prefers an experience that differs from that provided.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, selecting user-tailored search engine homepage experiences. Upon receiving a request for presentation of a search engine homepage from a user, known information about the user (for instance, user interests, search patterns and/or profile information) is accessed to facilitate determining the type of homepage experience the user desires to receive. The type of homepage experience the user desires to receive may include a user-tailored image to be presented as the background of the search engine homepage. Upon determining the type of experience the user desires, a search engine homepage experience is selected for the user. In this way, the user is provided with a search engine homepage experience that is tailored to his or her interests and behavior, thus increasing user satisfaction and engagement with the search engine homepage.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method for selecting a tailored search engine homepage experience based upon user-specific data points, in accordance with an embodiment of the present invention; and

FIG. 4 is a flow diagram showing an exemplary method for selecting a user-tailored search engine homepage background image for presentation, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, selecting user-tailored search engine homepage experiences. Upon receiving a request for presentation of a search engine homepage from a user, known information about the user (for instance, user interests, search patterns and/or profile information) is accessed to facilitate determining the type of homepage experience the user desires to receive. The type of homepage experience the user desires to receive may include a user-tailored image to be presented as the background of the search engine homepage. Upon determining the type of experience the user desires, a search engine homepage experience is selected for the user. In this way, the user is provided with a search engine homepage experience that is tailored to his or her interests and behavior, thus increasing user satisfaction and engagement with the search engine homepage.

Accordingly, one embodiment of the present invention is directed to one or more computer-readable storage media storing computer-useable instructions that, when used by one or more computing devices, cause the one or more computing devices to perform a method for selecting user-tailored search engine homepage experiences. The method includes receiving a request for presentation of a search engine homepage from a user, accessing one or more data points associated with the user, and selecting a tailored search engine homepage experience for the user based upon the one or more data points.

In another embodiment, the present invention is directed to a system for selecting user-tailored search engine homepage experiences. The system includes a computing device having one or more processors and one or more computer-readable storage media, a search server, and a data store coupled with the search server. The search server is configured to receive a request for presentation of a search engine homepage from a user, and access a plurality of data points associated with the user. Each of the plurality of user data points may include, without limitation, online behavior characteristics associated with the user, search patterns associated with the user, web site engagement patterns associated with the user, profile information associated with the user, personal data associated with the user, and patterns associated with other users determined to be similar to the user. The search server is further configured to select a tailored search engine homepage experience for the user based upon the one or more data points.

In yet another embodiment, the present invention is directed to a method being performed by one or more computing devices including at least one processor, for selecting user-tailored search engine homepage experiences. The method includes receiving a request for presentation of a search engine homepage from a user, and accessing a plurality of data points associated with the user. Each of the plurality of user data points may be derived from one or more of: online behavior characteristics associated with the user, search patterns associated with the user, web site engagement patterns associated with the user, profile information associated with the user, personal data associated with the user, and patterns associated with other users determined to be similar to the user. The method further includes selecting a tailored search engine homepage experience for the user based upon at least a portion of the user data points, the user-tailored search engine homepage experience including a user-tailored search engine homepage image.

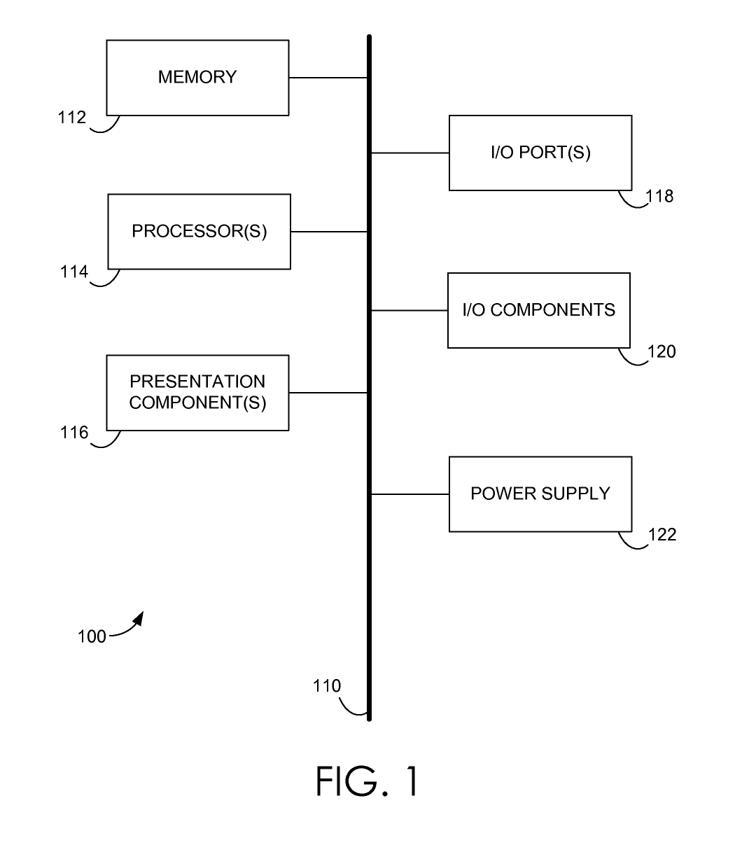

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that can be accessed by the computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above are also included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

As previously mentioned, embodiments of the present invention are generally directed to systems, methods, and computer-readable storage media for, among other things, selecting user-tailored search engine homepage experiences. Upon receiving a request for presentation of a search engine homepage from a user, known information about the user (for instance, user interests, search patterns and/or profile information) is accessed to facilitate determining the type of homepage experience the user desires to receive. The type of homepage experience the user desires to receive may include a user-tailored image to be presented as the background of the search engine homepage. Upon determining the type of experience the user desires, a search engine homepage experience is selected for the user. In this way, the user is provided with a search engine homepage experience that is tailored to his or her interests and behavior, thus increasing user satisfaction and engagement with the search engine homepage.

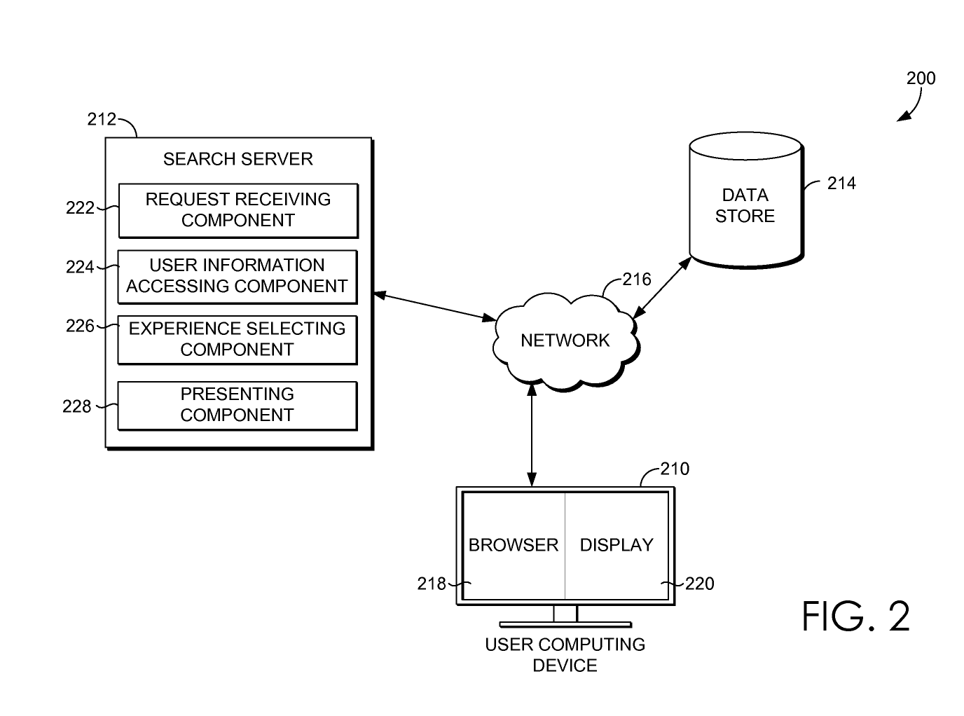

Referring now to FIG. 2, a block diagram is provided illustrating an exemplary computing system 200 in which embodiments of the present invention may be employed. Generally, the computing system 200 illustrates an environment in which user-tailored search engine homepage experiences may be selected. Among other components not shown, the computing system 200 generally includes a user computing device 210, a search server 212, and a data store 214, all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

It should be understood that any number of user computing devices and search servers may be employed in the computing system 200 within the scope of embodiments of the present invention. Each may comprise a single device/interface or multiple devices/interfaces cooperating in a distributed environment. For instance, the search server 212 may comprise multiple devices and/or modules arranged in a distributed environment that collectively provide the functionality of the search server 212 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the user computing device 210, as an Internet-based service, or as a module inside the search server 212. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search servers or user computing devices. By way of example only, the search server 212 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the client computing device 210 includes a browser 218 and a display 220. The browser 218, among other things, is configured to render search engine home pages (or other online landing pages), in association with the display 220 of the client computing device 210. The browser 218 is further configured to receive user input of requests for various web pages (including search engine home pages), receive user input search queries (generally input via a user interface presented on the display 220 and permitting alpha-numeric and/or textual input into a designated search box) and to receive content for presentation on the display 220, for instance, from the search server 212. It should be noted that the functionality described herein as being performed by the browser 218 may be performed by any other application capable of rendering Web content. Any and all such variations, and any combination thereof, are contemplated to be within the scope of embodiments of the present invention.

As previously set forth, embodiments of the present invention provide systems and methods for selecting user-tailored search engine homepage experiences. Search engine homepages or other landing pages from which a search may be conducted oftentimes include content in addition to a designated search box configured to permit alpha-numeric and/or textual input related to a desired query. Such content may include, by way of example only, an image (e.g., a background image having the designated search box overlaid thereupon), a color (for instance, a background color having an image and/or a designated search box overlaid thereupon), or interactive user interface elements, that is, a specified regions within the search engine homepage that, upon user interaction therewith, additional information or functionality is provided. The content may additionally include one or more page tiles or regions containing specific information, such as news headlines, weather information, user recent search history, and the like. One exemplary search engine homepage that includes some or all of such content is the BING search engine homepage provided by Microsoft Corporation of Redmond, Wash.

Typically, the bulk of the search engine homepage experience is provided by the accompanying search engine and is static for all users (with the exception of categorical changes based on a user's market and/or language, and changes in specific aspects of the homepage, for instance, the specific-information tiles that may be presented in association with the search engine homepage). In accordance with embodiments of the present invention, the search engine homepage experience as a whole may be tailored to a user's profile, behavior, interests, and the like, thus providing a more interesting and engaging experience for the user.

Accordingly, the search server 212 of FIG. 2, is configured to receive and respond to requests that it receives from components associated with user computing devices, for instance, the browser 218 associated with the client computing device 210. Those skilled in the art of the present invention will recognize that embodiments of the present invention may be implemented with any number of searching utilities. For example, an Internet search engine or a database search engine may utilize the present invention. These search engines are well known in the art, and commercially available engines share many similar processes not further described herein.

As illustrated, the search server 212 includes a request receiving component 222, a user information accessing component 224, an experience selecting component 226, and a presenting component 228. The illustrated search server 212 also has access to a data store 214. The data store 214 is configured to store information pertaining to search engine homepage content. In various embodiments, such information may include, without limitation, images (e.g., images to be displayed as search engine homepage background images), interactive user interface elements, and page tiles and associated content. The data store 214 is further configured to store information pertaining to specific users including, without limitation, online behavior characteristics associated with users, search patterns associated with users, web site engagement patterns associated with users, profile information associated with users, personal data associated with users, and patterns associated with other users determined to be similar to specific users. In embodiments, the data store 214 is configured to be searchable for one or more of the items stored in association therewith. It will be understood and appreciated by those of ordinary skill in the art that the information stored in association with the data store 214 may be configurable and may include any information relevant to a search engine homepage experience and/or user-specific data. The content and volume of such information are not intended to limit the scope of embodiments of the present invention in any way. Further, though illustrated as a single, independent component, the data store 214 may, in fact, be a plurality of storage devices, for instance a database cluster, portions of which may reside in association with the search server 212, the user computing device 210, another external computing device (not shown), and/or any combination thereof.

In accordance with embodiments hereof, images stored in association with the data store 214 may be tagged with information that may be compared with and matched to user data points (as more fully described below) in selecting an appropriate user-tailored search experience. Accordingly, the data store 214 is configured to store not only images but also the information tags associated with images, as appropriate.

The request receiving component 222 of the search server 216 is configured to receive requests for presentation of search engine homepages. Typically, such a request is received via a browser associated with a user computing device, for instance, the browser 218 associated with the user computing device 210.

The user information accessing component 224 is configured to access data points associated with a user requesting presentation of the search engine homepage. Such data points may include or be derived from, without limitation, online behavior characteristics associated with the requesting user, search patterns and other search history associated with the requesting user (including classes of queries the user historically has searched for, e.g., sports, finance, news, travel, and the like), web site engagement patterns associated with the requesting user, profile information associated with the requesting user, personal data associated with the requesting user (e.g., demographic information, geographic information, likes, interests, social networking data, and the like), and patterns associated with other users determined to be similar to the requesting user. Examples include, without limitation, domains previously and/or frequently visited by the user, the user's entry point to the search engine homepage (that is, the web site from which the user requested presentation of the search engine homepage), destination Uniform Resource Locators for which the user has previously left a domain associated with the search engine homepage, a user agent stream associated with the user, and the day/time during which the user historically engages with the search engine homepage, the user's current location, and/or other frequented sites.

In embodiments wherein a user-tailored search engine homepage image is selected as part of the user-tailored search engine homepage experience, exemplary data points may further include, without limitation, the user's historical image engagement (e.g., interactive user interface element click-through, search behavior, activity, popular-now engagement, likelihood to share, and the like), follow-on behavior (e.g., post engagement behavior once the user has clicked on or left a search engine homepage image—how likely is the user to engage), image type (e.g., some users are more likely to engage with images of animals, landscapes, people, or the like), and image color patterns (e.g., some users are more likely to engage with images featuring primarily green coloring, blue coloring, or the like).

Additionally, in accordance with embodiments hereof, users may be provided the opportunity to explicitly express their endorsement (positive or negative) of particular images or other qualities of the search engine homepage experience. Such endorsements may be utilized as a data point to understand the search experiences the user enjoys and provides the ability for specification of categories of images and/or other qualities of the search engine homepage experience to select for the particular user. Similarly, in accordance with embodiments hereof, users may be provided the opportunity to select specific images or other qualities of the search engine homepage experience are their favorites. In this way, this knowledge may be leveraged to further inform the system of the present invention to select user-tailored search engine homepage experiences. Additionally, the user is provided the opportunity to select those things they like about the search engine homepage experience (including the search engine homepage image or portions thereof) that they like the best, making engagement with the search engine homepage more likely.

The experience selecting component 226 of the search server 212 is configured to select a user-tailored search engine homepage experience based upon the data points accessed (retrieved or received) for the user. For example, if the user arrives at the search engine homepage from a competitor search engine that is known for speed or performance, and subsequently does not engage with the search engine homepage, this information is captured, for instance, in a cookie associated with the user. Upon the user's return to the search engine homepage, this cookie may be utilized as a data point for selecting a search engine homepage tailored to the user and this user may be provided with an optimized version of the search engine homepage that loads faster and/or contains no images that could slow down speed.

In another example, search history may be leveraged to better understand what the user cares about and thus, to select an appropriate search engine homepage experience for the user. So, if a user's history indicates that they frequently interact with sports-related websites, in accordance with embodiments of the present invention, a sport scores/ticker may be dynamically added to the search engine homepage to provide the user with a more tailored search engine homepage experience.

In yet another example, in order to select an appropriate search engine homepage experience tailored for a particular user, there is a need to accurately gauge whether or not the user is interested in an alternate experience or if by changing the standard experience, they are being forced to change their habits. Thus, the experience selecting component 226 is configured to determine, based on a variety of user data points (primarily relating to search behavior and the methods the user utilizes to arrive at and leave the search engine homepage) what the user might prefer. If it is noticed that the user continually searches for a particular class of queries, finds unsatisfactory results and leaves the search engine homepage for a competitor search engine, the class of queries with which the user is struggling can be identified and websites and widgets, for instance, may be served up a part of the user-tailored search engine homepage experience to make finding the information the user desires more feasible.

In another example, the user's search engine homepage experience may be tailored based on how the user arrived at the search engine homepage. If the user came to the search engine homepage from a competitor search engine, search engine homepage content may be dynamically arranged and/or dropped in order to become more familiar to the user, without overwhelming them. In such a case, the user may be provided the option to switch out the experience to a default experience if they are provided an experience they are not happy with.

Still further, in accordance with embodiments hereof, the system includes the ability to cycle through a set of unique experiences (for instance, unique search engine homepage images) that are interesting to the user. The system also includes the ability to adapt and based on how the user interacts with each additional experience (e.g., image), to continue to store further data points around preferences and engagement (for instance, in association with the data store 214) for use when the user visits the search engine homepage subsequently.

The presenting component 228 of the search server 212 is configured to transmit (e.g., via the network 216) a requested search engine homepage experience for presentation in association with the display 220 of the user computing device 210. The presenting component 228 is further configured to transmit for presentation a designated search box configured to permit alpha-numeric and/or textual input to be entered for requesting a search to be performed.

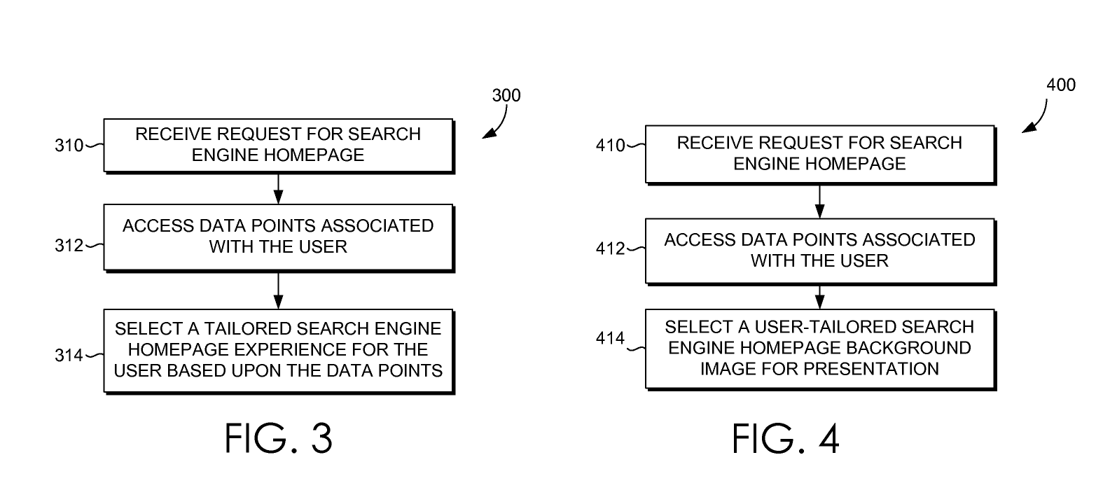

Turning now to FIG. 3, a flow diagram is illustrated showing an exemplary method 300 for selecting a tailored search engine homepage experience based upon user-specific data points, in accordance with an embodiment of the present invention. As indicated at block 310, a request for presentation of a search engine homepage is received from a user, for instance, received from a user associated with the user computing device 210 of FIG. 2 by the request receiving component 222 of the search server 212 via the network 216. As indicated at block 312, one or more user-specific data points are accessed, for instance, from the data store 214 of FIG. 2. As previously set forth, such data points may include or be derived from, by way of example only, online behavior of the requesting user, search patterns of the requesting user, web site engagement patterns of the requesting user, profile information associated with the requesting user, personal data associated with the requesting user, and/or patterns associated with other users determined to be similar to the requesting user. As indicated at block 314, a tailored search engine homepage experience for the requesting user is selected based upon the accessed data points, for instance, for presentation in association with the display of a user computing device associated with the requesting user.

With reference to FIG. 4, shown is a flow diagram illustrating another exemplary method 400 for selecting a user-tailored search engine homepage background image for presentation upon user request, in accordance with an embodiment of the present invention. As indicated at block 410, a request for presentation of a search engine homepage is received (e.g., by the request receiving component 222 of the search server 212 of FIG. 2 via the network 216) from a user, for instance, a user associated with the user computing device 210. As indicated at block 412, a plurality of data points associated with the user is accessed, for instance, from the data store 214 of FIG. 2. As previously described, such data points may include or be derived from, by way of example only, online behavior of the requesting user, search patterns of the requesting user, web site engagement patterns of the requesting user, profile information associated with the requesting user, personal data associated with the requesting user, and/or patterns associated with other users determined to be similar to the requesting user. As indicated at block 414, a user-tailored search engine homepage background image is selected for presentation in association with a computing device associated with the requesting user, for instance, for presentation in association with the display of a user computing device associated with the requesting user.

As can be understood, embodiments of the present invention provide systems and methods for selecting a user-tailored search engine homepage experiences (for instance, including search engine homepage images) for presentation upon request. Having the capability to tailor the search engine homepage experience based, for instance, on the user searching for a website that it can be deduced will cause them to leave the search engine homepage and go to a competitor search engine, provides the opportunity to delight users who seem to be in a situation where they are about to leave. By crafting and modifying the search engine homepage experience similar to the site they plan on leaving for provides the opportunity to keep the user and convert them to longer term users of the search engine associated with the search engine homepage.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 300 of FIGS. 3 and 400 of FIG. 4 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for selecting user-tailored search engine homepage experiences, the method comprising:
receiving a request for presentation of a search engine homepage from a user;
accessing one or more data points associated with the user; and
selecting a tailored search engine homepage experience for the user based upon the one or more data points.

2. The one or more computer-readable storage media of claim 1, wherein the one or more data points include user data points derived from one or more of: online behavior characteristics associated with the user, search patterns associated with the user, web site engagement patterns associated with the user, search engine homepage engagement patterns associated with the user, profile information associated with the user, personal data associated with the user, the user's current location, and patterns associated with other users determined to be similar to the user.

3. The one or more computer-readable storage media of claim 1, wherein the one or more user data points include a search history associated with the user.

4. The one or more computer-readable storage media of claim 1, wherein the one or more user data points include at least one domain the user has previously visited.

5. The one or more computer-readable storage media of claim 1, wherein the one or more user data points include a web site from which the user requested presentation of the search engine homepage.

6. The one or more computer-readable storage media of claim 1, wherein the one or more user data points include a destination Uniform Resource Locator for which the user has previously left a domain associated with the search engine homepage.

7. The one or more computer-readable storage media of claim 1, wherein the one or more user data points include a user agent stream associated with the user.

8. The one or more computer-readable storage media of claim 1, wherein the one or more user data points include at least one of a day during which the user historically engages with the search engine homepage, a time during which the user historically engages with the search engine homepage, and a location from which the user historically engages with the search engine homepage.

9. The one or more computer-readable storage media of claim 1, wherein selecting the user-tailored search engine homepage experience comprises selecting a user-tailored search engine homepage image based upon the one or more data points.

10. The one or more computer-readable storage media of claim 9, wherein the user-tailored search engine homepage image is selected by comparing tags associated with a plurality of potential search engine homepage images with the one or more user data points.

11. The one or more computer-readable storage media of claim 9, wherein the one or more user data points include at least one of image types with which the user historically engages, image color patterns with which the user historically engages, and feedback regarding images previously presented to the user.

12. A system for selecting user-tailored search engine homepage experiences, the system comprising:
a computing device having one or more processors and one or more computer-readable storage media;
a search server; and
a data store coupled with the search server,
wherein the search server:
receives a request for presentation of a search engine homepage from a user;
accesses a plurality of data points associated with the user, the plurality of user data points being derived from one or more of: online behavior characteristics associated with the user, search patterns associated with the user, web site engagement patterns associated with the user, profile information associated with the user, personal data associated with the user, and patterns associated with other users determined to be similar to the user; and
selects a tailored search engine homepage experience for the user based upon the one or more data points.

13. The system of claim 12, wherein the one or more user data points include at least one of a search history associated with the user; a domain the user has previously visited; a web site from which the request for presentation of the search engine homepage was received; a destination Uniform Resource Locator for which the user has previously left a domain associated with the search engine homepage; a user agent stream associated with the user; and at least one of a day and a time during which the user historically engages with the search engine homepage.

14. The system of claim 12, wherein the user-tailored search engine homepage experience includes a user-tailored search engine homepage image.

15. The system of claim 14, wherein the search server selects the user-tailored search engine homepage image by comparing tags associated with a plurality of potential search engine homepage images with the one or more user data points.

16. The system of claim 14, wherein the one or more data points include at least one of image types with which the user historically engages, image color patterns with which the user historically engages, and feedback regarding images previously presented to the user.

17. A method being performed by one or more computing devices including at least one processor, for selecting user-tailored search engine homepage experiences, the method comprising:
receiving a request for presentation of a search engine homepage from a user;
accessing a plurality of data points associated with the user, the plurality of user data points being derived from one or more of: online behavior characteristics associated with the user, search patterns associated with the user, web site engagement patterns associated with the user, profile information associated with the user, personal data associated with the user, and patterns associated with other users determined to be similar to the user; and
selecting a tailored search engine homepage experience for the user based upon at least a portion of the user data points, the user-tailored search engine homepage experience including a user-tailored search engine homepage image.

18. The method of claim 17, wherein at least a portion of the plurality of user data points include one or more of a search history associated with the user; a domain the user has previously selected; a web site from which the request for presentation of the search engine homepage was received; a destination Uniform Resource Locator for which the user has previously left a domain associated with the search engine homepage; a user agent stream associated with the user; and at least one of a day and a time during which the user historically engages with the search engine homepage.

19. The method of claim 17, wherein the method further comprises selecting the user-tailored search engine homepage image by comparing tags associated with a plurality of potential search engine homepage images with the plurality of user data points.

20. The method of claim 18, wherein at least a portion of the plurality of user data points includes at least one of image types with which the user historically engages, image color patterns with which the user historically engages, and feedback regarding images previously presented to the user.
